(19) United States
(12) Patent Application Publication
(10) Pub. No.: US 2003/0016473 A1
(43) Pub. Date: Jan. 23, 2003

(54) Actuator design for reducing track misregistration

(76) Inventor: Seonghoon Kim, Cupertino, CA (US)

Correspondence Address: IRELL & MANELLA LLP, 840 NEWPORT CENTER DRIVE, SUITE 400, NEWPORT BEACH, CA, 92660, US

(21) Appl. No.: 10/026,048

(22) Filed: Dec. 21, 2001

Related U.S. Application Data
(60) Provisional application No. 60/306,735, filed on Jul. 19, 2001.

(51) Int. Cl. G11B 5/55

(52) U.S. Cl. 360/266

(57) ABSTRACT

An actuator arm of a hard disk drive. The actuator arm has a tapered aft end that reduces the vortices formed within an internal air flow of the disk drive. The air flow is created by the rotating disks of the drive. Reducing the vortices decreases the air induced vibration of the actuator arm and improves the stability of the heads coupled to the arm. The tapered end preferably has an angle less than 30 degrees.

### REFERENCE TO CROSS-RELATED APPLICATIONS

This application claims priority to provisional application No. 60/306,735 filed on Jul. 19, 2001.

### BACKGROUND OF THE INVENTION

1. Field of the Invention

The subject matter disclosed generally relates to the field of hard disk drives.

2. Background Information

Hard disk drives contain a plurality of magnetic heads that are coupled to rotating disks. The heads write and read information by magnetizing and sensing the magnetic fields of the disk surfaces. There have been developed magnetic heads that have a write element for magnetizing the disks and a separate read element for sensing the magnetic fields of the disks. The read element is typically constructed from a magneto-resistive material. The magneto-resistive material has a resistance that varies with the magnetic fields of the disk. Heads with magneto-resistive read elements are commonly referred to as magneto-resistive (MR) heads.

Each head is attached to a flexure arm to create an subassembly commonly referred to as a head gimbal assembly (“HGA”). The HGA's are attached to an actuator arm that has a voice coil coupled to a magnet assembly. The voice coil and magnet assembly create a voice coil motor that can pivot the actuator arm and move the heads across the disks.

Information is typically stored within annular tracks that extend across each surface of a disk. The voice coil motor can move the heads to different track locations to access data stored on the disk surfaces. Each track is typically divided into a plurality of adjacent sectors. Each sector may have one or more data fields. Each data field has a series of magnetic transitions that are decoded into binary data. The spacing between transitions define the bit density of the disk drive. It is generally desirable to provide a high bit density to increase the overall storage capacity of the drive.

Each head has an air bearing surface that cooperates with an air flow generated by the rotating disk to create an air bearing. The air bearing prevents mechanical wear between the head and the disk. The air flow within the hard disk drive also creates drag and lift forces on the actuator arm. Additionally, the air flows across the actuator arm in a manner that may create vortices in the trailing edge of the arm. The vortices can create turbulence and vibration in the actuator arm. The vibration can cause undesirable movement of the heads that reduce the stability of the system and decrease the bit density of the drive.

### BRIEF SUMMARY OF THE INVENTION

An actuator arm of a hard disk drive that has a tapered aft end. The tapered actuator arm may reduce vortices formed within an internal air flow of the disk drive.

### BRIEF DESCRIPTION OF THE DRAWINGS

FIG. 1 is a top view of an embodiment of a hard disk drive of the present invention;

FIG. 2 is a side view of an E-block of an actuator arm;

FIG. 3 is a cross-sectional view of an actuator arm;

FIG. 4 is a graph showing pressure versus air flow for different tapered actuator beam angles.

### DETAILED DESCRIPTION

Disclosed is an actuator arm of a hard disk drive. The actuator arm has a tapered aft end that reduces the vortices formed within an internal air flow of the disk drive. The air flow is created by the rotating disks of the drive. Reducing the vortices decreases the air induced vibration of the actuator arm and improves the stability of the heads coupled to the arm. The tapered end preferably has an angle less than 75 degrees.

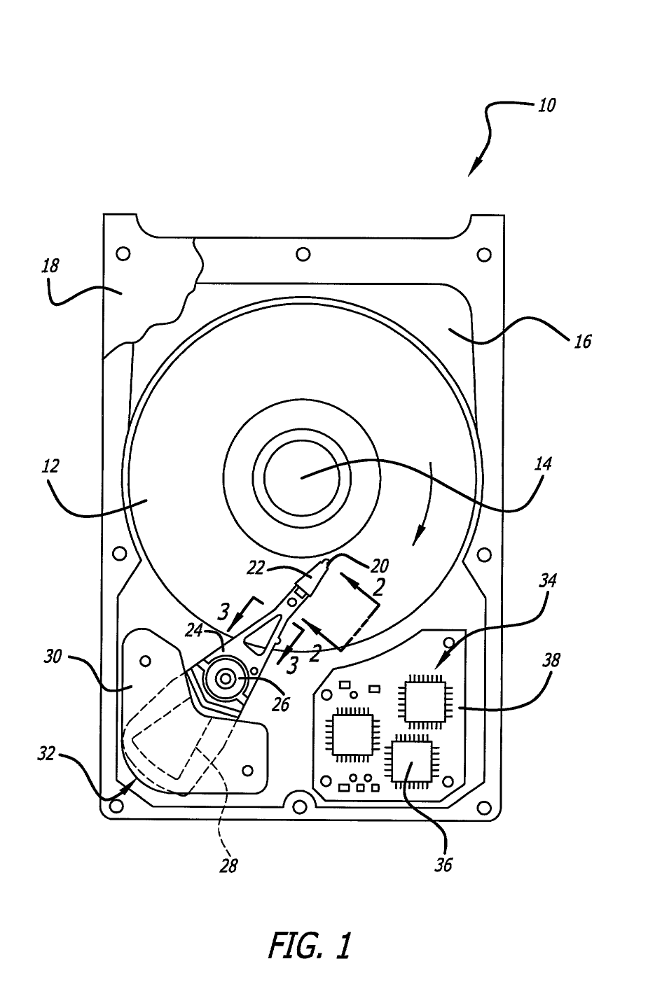

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear. The formation of the air bearing and the general operation of the head 20 is a function of a force exerted by the flexure arm 22.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

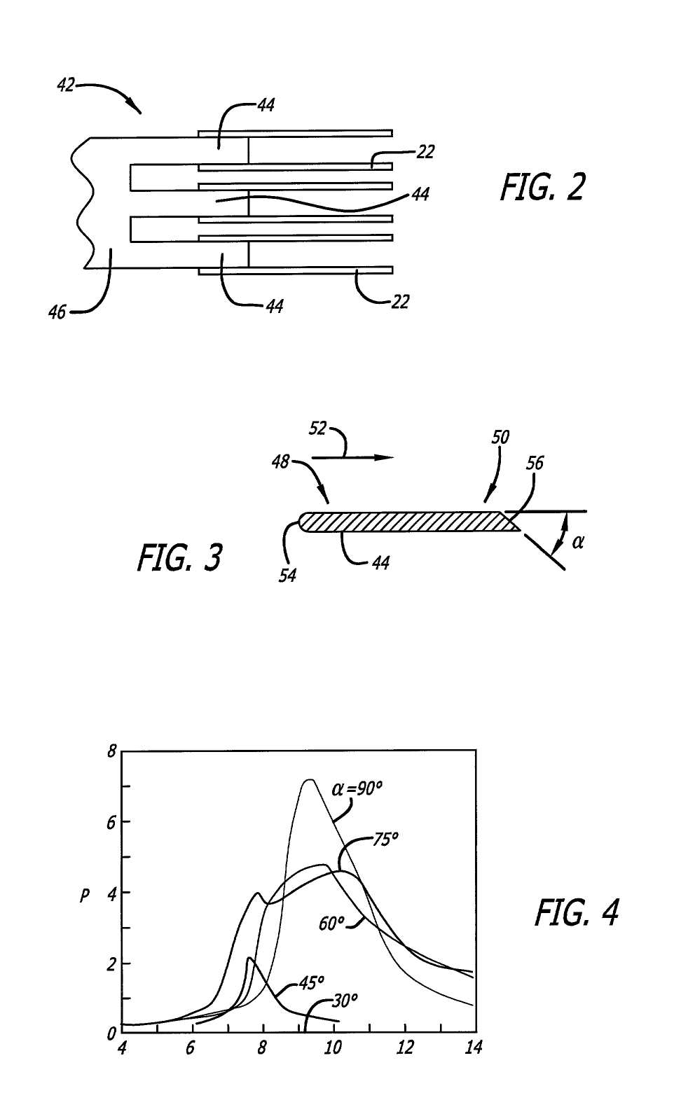

FIG. 2 shows a portion of the actuator arm 24 commonly referred to as an E-block 42. The E-block 42 includes a plurality of actuator arms 44 that extend from a base portion 46. Flexure arms 22 are attached to the actuator arms 44.

FIG. 3 shows a cross-section of an actuator arm 44 that has a fore end 48 and an aft end 50. The fore end 48 being the forward portion of the arm 44 relative to the air flow 52 created by the rotating disks 12. The fore end 48 may have a rounded edge 54.

The aft end 50 may have a tapered surface 56. The tapered surface 56 reduces the instability of the arm and the air induced vibrational movement of the heads. It is generally desirable to reduce the pressure fluctuations on the actuator beam 44 to provide a more stable operating system. Fluctuating pressure varies the lift and drag forces. Additionally, fluctuating pressure will also change vortex formation that can destabilize the operation of the heads. The tapered surface 56 reduces and may actually eliminate the symmetry of vortex shedding. This improves the stability of the actuator arm 44.

FIG. 4 shows a graph of pressure versus Reynolds number (air flow velocity) as a function of different tapered surface angles. As can be seen a tapered angle of 30 degrees or less minimizes the pressure fluctuations in response to changes in the velocity of the air flow. Minimizing pressure fluctuations will reduce the amount of air flow induced vibration and improve the stability of head operation. It is therefore desirable to provide a tapered surface that has an angle no greater than 30 degrees.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An actuator arm for a hard disk drive, comprising:
a base portion;
an arm that extends from said base portion, said arm having a fore end and an aft end, said aft end having a tapered surface.

2. The actuator arm of claim 1, wherein said tapered surface has an angle less that 30 degrees.

3. The actuator arm of claim 1, wherein said fore end has a rounded edge.

4. An actuator arm assembly for a hard disk drive, comprising:
an actuator arm, said arm having a fore end and an aft end, said aft end having a tapered surface;
a flexure arm coupled to said actuator arm;
a head coupled to said flexure arm.

5. The actuator arm assembly of claim 4, wherein said tapered surface has an angle less that 30 degrees.

6. The actuator arm assembly of claim 4, wherein said fore end has a rounded edge.

7. A hard disk drive, comprising:
a base plate;
a spindle motor coupled to said base plate;
a disk coupled to said spindle motor;
an actuator arm mounted to said base plate, said actuator arm having a fore end and an aft end, said aft end having a tapered surface;
a voice coil motor coupled to said actuator arm;
a flexure arm coupled to said actuator arm; and,
a head coupled to said flexure arm and said disk.

8. The hard disk drive of claim 7, wherein said tapered surface has an angle less that 75 degrees.

9. The hard disk drive of claim 7, wherein said fore end has a rounded edge.

10. A method for operating a hard disk drive, comprising:
rotating a disk that creates an air flow across an actuator beam, the actuator beam having a tapered surface located at an aft end that reduces the symmetry of vortices in the air flow.

11. The method of claim 10, wherein the tapered surface is less than 75 degrees.
